(19) United States
(12) Patent Application Publication
(10) Pub. No.: US 2016/0078346 A1
(43) Pub. Date: Mar. 17, 2016

(54) DYNAMIC PREDICTIVE ANALYSIS IN PRE-BID OF ENTITIES

(71) Applicant: PAUL PALLATH, BANGALORE (IN)

(72) Inventor: PAUL PALLATH, BANGALORE (IN)

(21) Appl. No.: 14/483,440

(22) Filed: Sep. 11, 2014

(51) Int. Cl. G06N 5/04; G06N 7/00

(52) U.S. Cl. CPC G06N 5/04; G06N 7/00

(57) ABSTRACT

Strategy parameters and weights associated with the strategy parameters are received in a predictive analytics application to dynamically rank entities. Raw values associated with the strategy parameters are normalized by applying transformation functions to get normalized values. Based on the normalized values and the weights associated with the strategy parameters, weighted normalized values are computed. Based on the weighted normalized values aggregate scores are computed. The entities based on the computed aggregate score are dynamically ranked. The dynamically ranked entities in descending order of aggregate scores are displayed in a user interface of the predictive analytics application.

### BACKGROUND

In sports such as cricket, football, etc., franchisee or independent agencies pre-bid entities such as players. These franchisee or independent agencies typically pre-bid entities based on a preconceived notion of the entities, or based on qualitative facts associated with the entities such as a recent success of a player with an extra-ordinary score in a particular match. Quantitative facts associated with the entities include data in large volumes both at a macro level and at a granular level. Though quantitative facts include data collection at granular level, typically, the quantitative facts appears as information overload due to lack of efficient analysis. Analyzing such quantitative facts to generate insights to enable efficient pre-bidding is challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating an example environment for dynamic predictive analysis in pre-bid of entities, according to one embodiment.

FIG. 2 illustrates a user interface of a predictive analytics application, to facilitate dynamically ranking players using strategy parameters and weights associated with the strategy parameters, according to one embodiment.

FIG. 3 is a flow diagram illustrating a process of dynamically ranking players using strategy parameters and weights associated with the strategy parameters, according to one embodiment.

FIG. 4 illustrates a user interface to facilitate applying filter parameters in dynamically ranking players, according to one embodiment.

FIG. 5 illustrates a user interface to facilitate switching off filter parameters in dynamically ranking players, according to one embodiment.

FIG. 6 illustrates a user interface to facilitate comparing players in predictive analytics application, according to one embodiment.

FIG. 7 illustrates clustering to identify similar players in predictive analytics application, according to one embodiment.

FIG. 8 illustrates a user interface to displaying similar players in predictive analytics application, according to one embodiment.

FIG. 9 is a flow diagram illustrating a process of live auction using pre-bid players, according to one embodiment.

FIG. 10 is a block diagram illustrating an exemplary computer system, according to one embodiment.

### DETAILED DESCRIPTION

Embodiments of techniques for dynamic predictive analysis in pre-bid of entities are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

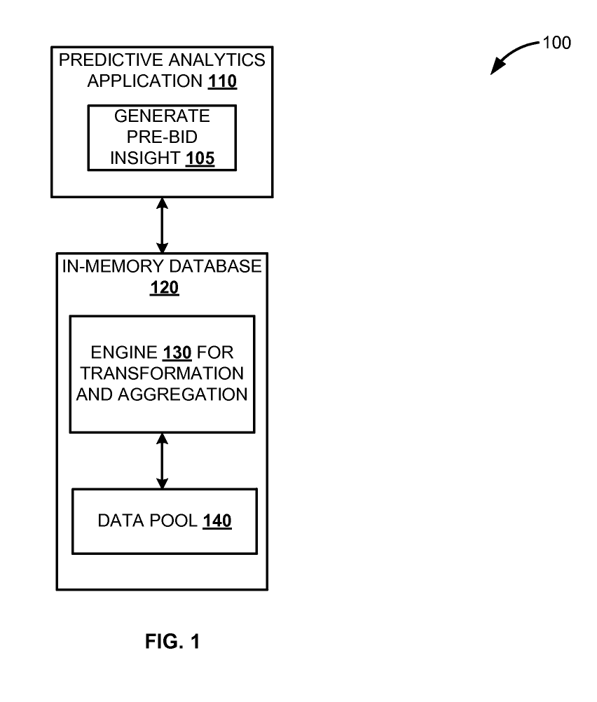

FIG. 1 is a block diagram illustrating example environment 100 for dynamic predictive analysis in pre-bid of entities, according to one embodiment. The environment 100 as shown contains predictive analytics application 110 and in-memory database 120. Merely for illustration, only representative number and types of systems and system modules are shown in FIG. 1. Other environments may contain more instances of predictive analytics applications and in-memory databases, both in number and type, depending on the purpose for which the environment is designed.

A category of entities can be selected and a request for pre-bid insight generation can be triggered using ‘generate pre-bid insight’ 105 option. ‘Generate pre-bid insight’ 105 option is merely exemplary, depending on a context or type of application, this option may vary. When the ‘generate pre-bid insight’ 105 option in predictive analytics application 110 is selected/activated, an automatic request to in-memory database 120 is sent for performing predictive analytics operations on data pool 140 available in the in-memory database 120. Engine 130 in the in-memory database 120 may perform predictive analytics operations such as feature extraction, normalization, transformation, segmentation, comparison and aggregation of the data retrieved from the data pool 140, etc. These predictive analytics operations result in dynamic generation of insights for pre-bid of entities. The dynamically generated pre-bids of entities may be ranked and displayed in a graphical user interface.

The connectivity between the predictive analytics application 110 and the in-memory database 120 may be implemented using any standard protocols such as Transmission Control Protocol (TCP) and/or Internet Protocol (IP), etc. The predictive analytics application 110 can be executed as a mobile application on hand held mobile devices, electronic tablets, etc., or can also be executed as a web application through a browser, e.g., running on s desktop computer.

For example, consider a sport, namely cricket, where premier league championship tournaments are conducted. Data associated with players from various countries are available in a data pool. In this scenario, referring players as entities is merely exemplary. Depending on the context or application, entities may vary such as employee, students, etc. Independent agencies auction these players from the data pool for franchisees to buy the players and represent their franchisee during the championship tournaments for a predefined period of time. To facilitate a franchisee to strategically choose and auction players, dynamic predictive analysis is used in the predictive analytics application. Players in the data pool may have data associated with previous matches that include various parameters associated with the players. Typically, for a sport like cricket, data aggregators are involved in compiling detailed information from disparate databases on individual matches referred to as time series data. A time series is a sequence of data points measured typically at successive points in time at a uniform time interval. For the sport cricket, time series data could be received from a data aggregator which includes granular level data corresponding to matches played by a player over the past years. The time series data of individual players have various parameters associated with the individual players.

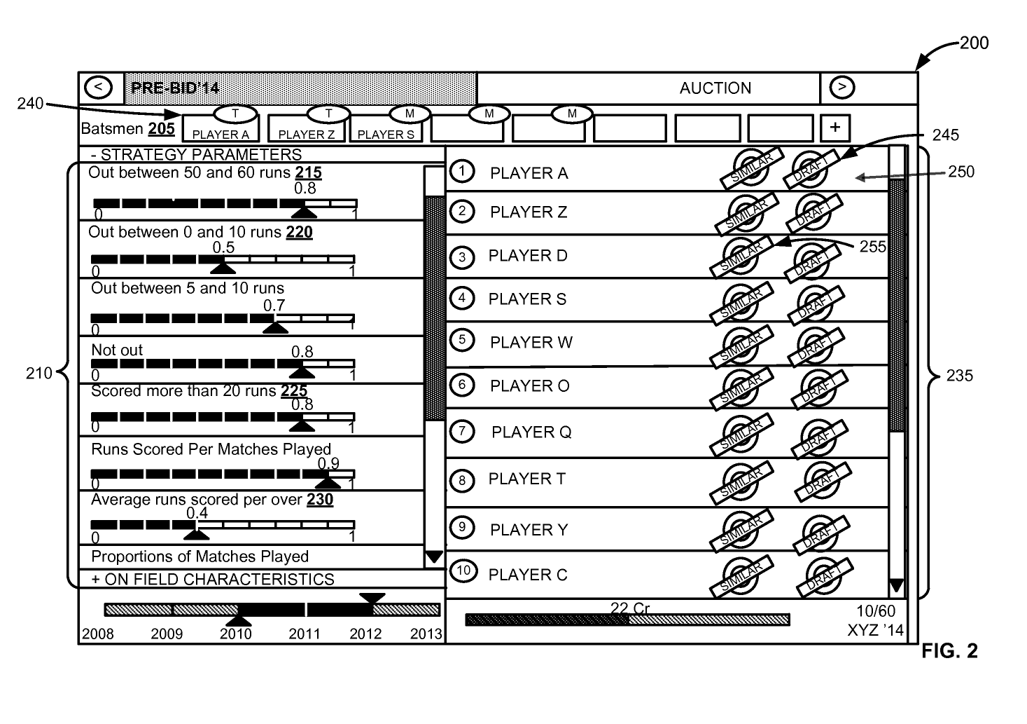

FIG. 2 illustrates user interface 200 of a predictive analytics application, to facilitate dynamically ranking players using strategy parameters and weights associated with the strategy parameters, according to one embodiment. In the example considered above, when a franchisee intends to participate in the bidding to nominate themselves for the championship tournament, the franchisee may have a strategy in shortlisting players from a data pool of players available in a database which is facilitated by the pre-bid feature of the predictive analytics application. The predictive analytics application provides the franchisee with capabilities to create strategies to rank players, filter the ranked players based on selected criteria, re-rank players in multiple dimensions like performance of a player against a team, performance of a player in a specific ground, etc. Players can be categorized in various categories such as batsman, bowler, all-rounder, etc., based on their individual performance and past records.

In this pre-bid scenario, strategy parameters are defined for selection of players in ‘batsmen’ 205 category. Various strategy parameters defined by the franchisee are displayed as shown in window 210. The various strategy parameters are ‘out between 50 and 60 runs’ 215 which represents number of times a player was out between 50 and 60 runs, ‘out between 0 and 10 runs’ 220 represents number of times a player was out between 0 and 10 runs, ‘scored more than 20 runs’ 225 which represents number of times a players scored more than 20 runs in prior matches, ‘average runs scored per over’ 230 which represents ordering of players based on the average runs scored per over, etc. These individual strategy parameters are associated with weights which indicate the importance associated with a strategy parameter. For the strategy parameter ‘out between 50 and 60 runs’ 215 weight of 0.8 is associated, for the strategy parameter ‘out between 0 and 10 runs’ 220 weight of 0.5 is associated, for the strategy parameter ‘average runs scored per over’ 230 weight of 0.4 is associated, etc.

Some strategy parameters such as ‘average runs scored per over’, ‘number of sixes’, etc., may have higher values or lower values. The same strategy parameter ‘average runs scored per over’ can be interpreted differently depending on the category. For example, if the ‘average runs scored per over’ by a batsman is higher, it is advantageous for a batsman, on the contrary, if the ‘average runs scored per over’ by a bowler is lower, it is advantageous for a bowler. Some strategy parameters such as ‘runs scored per matches played’, ‘runs scored per balls played’, etc., have distinct raw values and are independent of each other and cannot be compared with one another to retrieve players from the data pool. Further, when a group of batsmen, who have scored an average of 10 runs, 40 runs, 80 runs, 90 runs, 100 runs, etc. Some batsmen have scored as low as 10 runs and some batsmen have scores as high as 100 runs, when these batsmen are considered for comparison, there is no common scale for comparison. Accordingly, these strategy parameters are normalized to transform raw values to normalized values for comparison.

For ‘batsmen’ 205 category, consider a strategy parameter ‘average runs scored per over’ 230 which is to be transformed to normalized values. As a first step, value of this strategy parameter ‘average runs scored per over’ is divided by a corresponding divisor ‘total number of overs’ relevant to the strategy parameter to get raw values. As a second step, exponential transformation function or exponential transformation equation shown below is applied on these raw values to calculate score.

A. Score=Σᵢ₌₁wᵢ*e^{-1*α}^{ᵢ}

B. Score=Σⱼ₌₁wⱼ*(1−e^{-1*β}^{ⱼ})

where, αᵢ is a value of i^{th} parameter for which lower values of the parameter are advantageous, wᵢis a weight, βᵢ is a value of j^{th} parameter for which higher values of the parameter are advantageous and wⱼ is a weight.

If the strategy parameter being a lower value is advantageous for a specific category then equation A is applied. If the strategy parameter being a higher value is advantageous for a specific category then equation B is applied. For ‘batsmen’ category, a higher ‘runs scored per over’ is advantageous, and accordingly, equation B is applied. For example, consider ‘player A’, as a first step, value of ‘runs scored’ ‘2000’ is divided by the corresponding divisor value of ‘total number of overs’ ‘350’ relevant to the strategy parameter to get a raw value of ‘5.7’ ‘runs scored per over’. If the ‘runs scored per over’ is higher it is advantageous for the batsmen, accordingly equation B is applied as a second step. In the second step, exponential transformation equation B is applied to get (1−e^{-1*5.7})=0.996654 normalized value. This normalized value 0.996654 is multiplied with the weight 0.4 associated with the strategy parameter resulting in value of B is 0.996654*0.4=0.398662. The value 0.398662 is computed as a score for the strategy parameter.

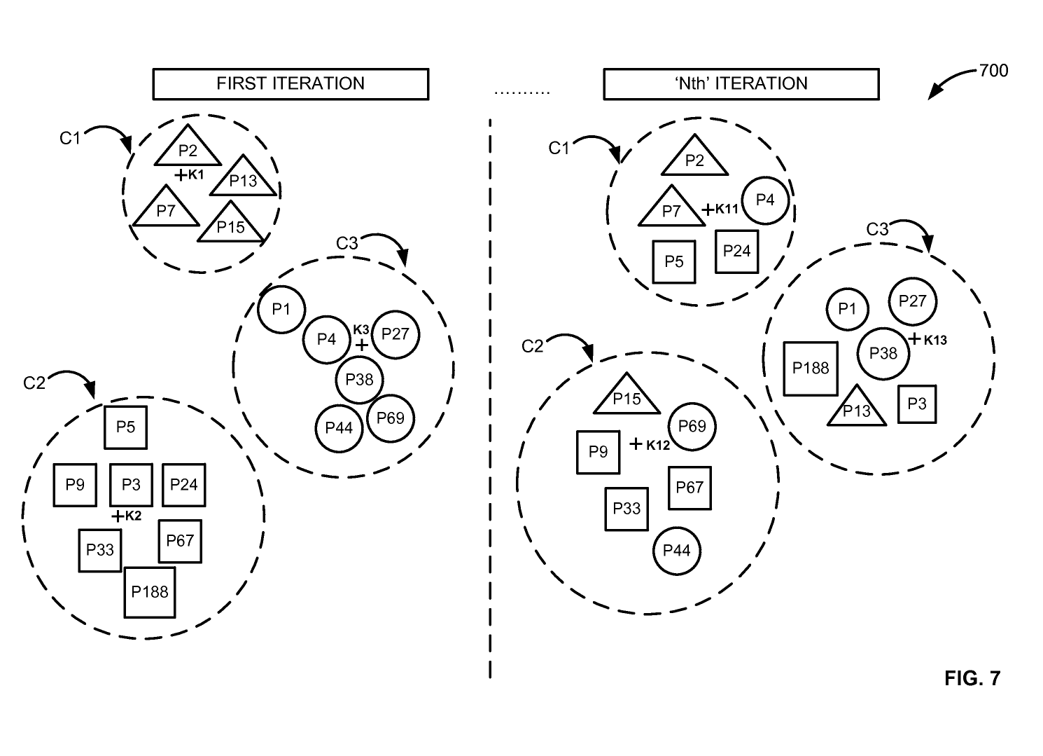

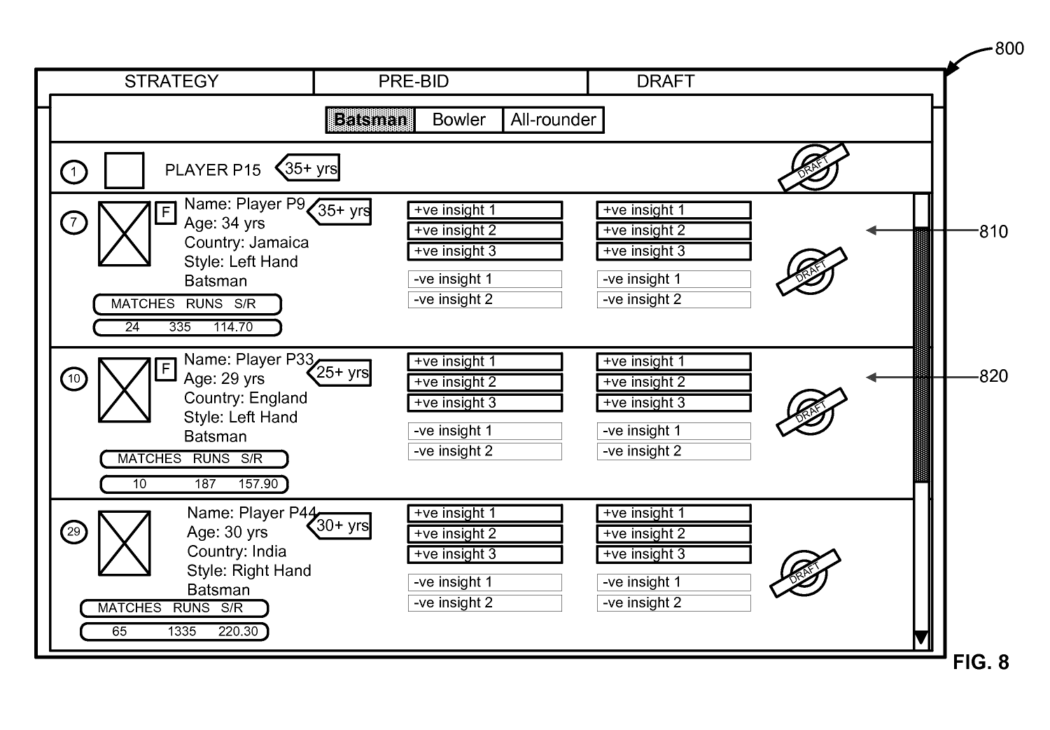

Similarly, score is computed for all the strategy parameters for a player, and these individual scores are added to compute an aggregate score for the player. Aggregate scores are computed for all the players in the ‘batsmen’ category. The players are dynamically ranked in descending order of computed aggregate scores and displayed as shown in window 235, such as ‘Player A’ in first rank, ‘Player Z’ in second rank, ‘Player D’ in third rank, etc. The ranked players can be moved to shortlisted list 240 in the pre-bid using a ‘draft’ option. For example, when draft option 245 is selected in row 250, ‘player A’ is selected and moved to the shortlisted list 240. Similarly, using the corresponding draft options, multiple players such as ‘player Z’, ‘player S’, etc., can be selected and moved to the shortlisted list 240. In the shortlisted list 240, players indicated by ‘T’ denote top order batsmen, ‘M’ denotes middle order batsmen, etc. Players similar to the ranked players can be identified using corresponding ‘similar’ option (e.g., ‘similar’ option 255 for ‘player D’). Identifying similar players is explained in details with reference to FIG. 7 and FIG. 8.

In one embodiment, for ‘all-rounder’ category, the players can be either a predominant batsman and a bowler referred to as batsman all-rounder, or a predominant bowler and batsman referred to as bowler all-rounder. In a scenario of a batsman all-rounder, based on the strategy parameter associated with batsman, a batsman score is computed, and based on the strategy parameter associated with bowler, a bowler score is computed. Since the player is a batsman all-rounder a weight of ‘1’ is assigned to score associated with batsman, and a weight of ‘0.5’ is assigned to the score associated with bowler. Weight ‘1’ is multiplied with the batsman score and the weight ‘0.5’ is multiplied with the bowler score. Sum of the batsman score and the bowler score gives a batsman all-rounder score. Based on the batsman all-rounder score, players are dynamically ranked. This can be indicated in an equation as,

Batsman all_rounder score=1*Score (batsman)+0.5*Score (bowler)

Similarly, in a scenario of a bowler all-rounder, a weight of ‘0.5’ is assigned to the score associated with batsman and a weight of ‘1’ is assigned to the score associated with bowler. This can be indicated in an equation as,

Bowler all_rounder score=1*Score (bowler)+0.5*Score (batsman)

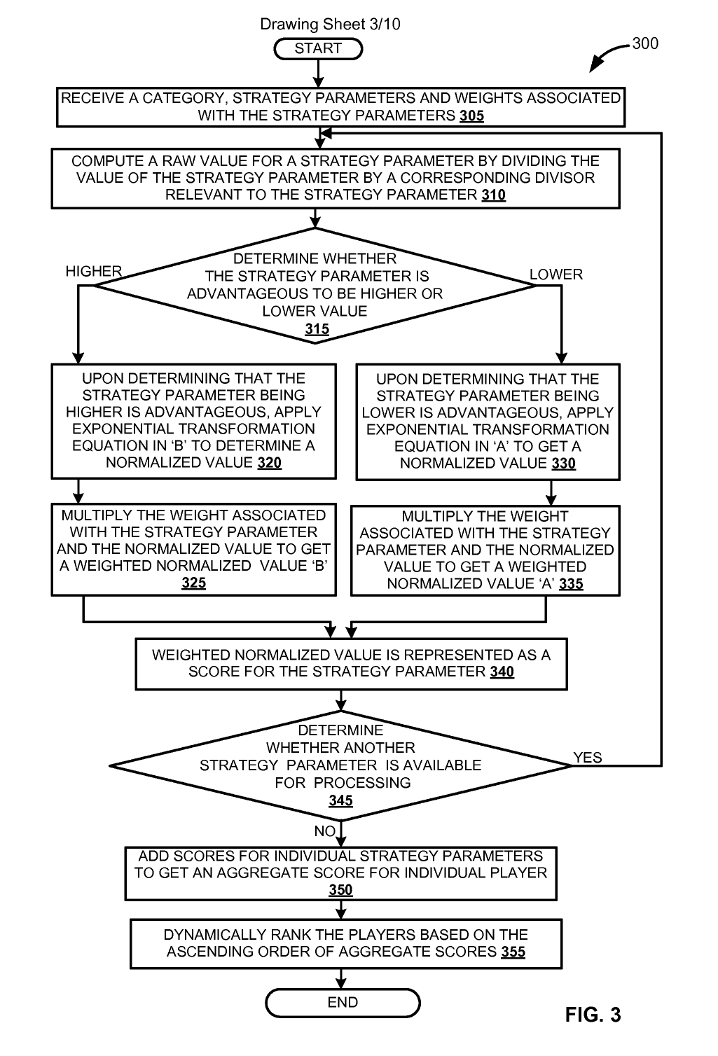

In one embodiment, weights associated with the strategy parameters can be varied or adjusted dynamically to reorder and dynamically re-rank players. The franchisee can have a varied perspective of dynamically ranked players by dynamically adjusting weights associated with the strategy parameters. FIG. 3 is a flow diagram illustrating process 300 of dynamically ranking players using strategy parameters and weights associated with the strategy parameters, according to one embodiment. At 305, a category, strategy parameters and weights associated with the strategy parameters are received in a user interface of predictive analytics application. At 310, for a player in a data pool, a raw value of a strategy parameter is computed, e.g., by dividing a value of the strategy parameter by a corresponding divisor relevant to the strategy parameter. At 315, it is determined whether the strategy parameter is advantageous to be a higher value or a lower value. Upon determining that the strategy parameter being a higher value is advantageous, at 320, the computed raw value is applied to (1−e^{-1*β}) and a normalized value is determined. At 325, the normalized value and the weight w associated with the strategy parameter are multiplied to get a weighted normalized value.

Upon determining that the strategy parameter being a lower value is advantageous, at 330, the computed raw value is applied to e^{-1*∝} and a normalized value is determined. At 335, the normalized value and the weight w associated with the strategy parameter are multiplied to get a weighted normalized value. At 340, the weighted normalized value is represented as a score for the strategy parameter. At 345, it is determined whether another strategy parameter is available for processing. Upon determining that another strategy parameter is available for processing, the corresponding steps 310 to 340 are executed. Thus, scores are computed for the remaining strategy parameters for the player. At 350, the computed scores for the strategy parameters are added to get an aggregate score for the player. Similarly, steps 310 to 350 may be performed to compute aggregate scores for other players in the data pool. At 355, the players are dynamically ranked, e.g., in descending order of aggregate scores, and the ranked players are displayed in the user interface of predictive analytics application.

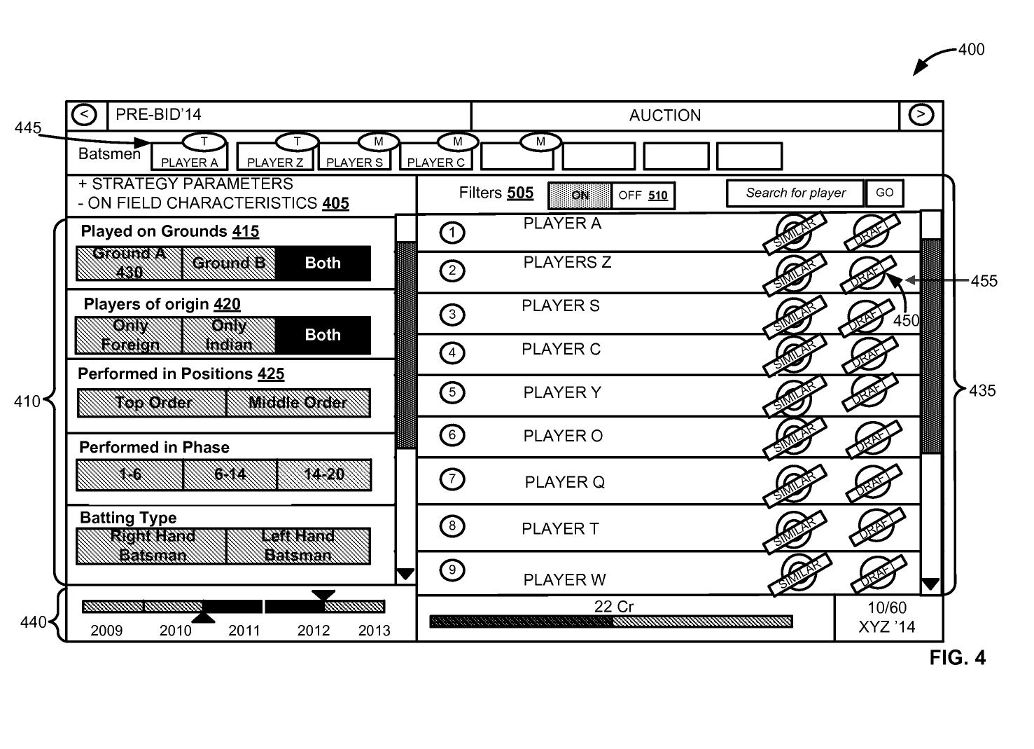

FIG. 4 illustrates user interface 400 to facilitate applying filter parameters in dynamically ranking players, according to one embodiment. In the pre-bid example scenario considered in reference to FIG. 2, strategy parameters are defined for selection of players in batsmen category. Apart from strategy parameters, various other filter parameters such as ‘on field characteristics’ 405 can be defined as shown in window 410. ‘On field characteristics’ 405 include parameters such as ‘played on grounds’ 415, ‘players of origin’ 420, ‘performed in positions’ 425, etc. The type and number of parameters in the filter parameter ‘on field characteristics’ can be user defined. For example, when ‘ground A’ 430 is selected in the ‘played on grounds’ 415, players qualifying the criteria of having played in ‘ground A’ 430 are selected and dynamically ranked, e.g., according to steps 305 to 355 as explained in reference to FIG. 3. The dynamically ranked or reordered players may be displayed in window 435 of the predictive analytics application.

Similarly, based on the options selected on other ‘on field characteristics’ 405, players are filtered, dynamically ranked, reordered, and displayed. Additional filters such as filtering by timeline in terms of years can be specified in window 440. For example, when years 2010 to 2012 is selected, the players meeting these criteria are filtered, dynamically ranked (e.g., according to steps 305-355 in FIG. 3), and displayed in window 435, such as ‘Player A’ in first rank, ‘Player Z’ in second rank, ‘Player S’ in third rank, etc. Any range of years can be selected as additional filters. These additional filters specified are also saved as filter parameters associated with the strategy parameters. The ranked players can be moved to shortlisted list 445 using the ‘draft’ option corresponding to the players. For example, when draft option 450 is selected at row 455, ‘player Z’ is selected and moved to the shortlisted list 445. Similarly, using the corresponding draft option, other players such as ‘player S’ and ‘player C’ can be selected and moved to the shortlisted list 445.

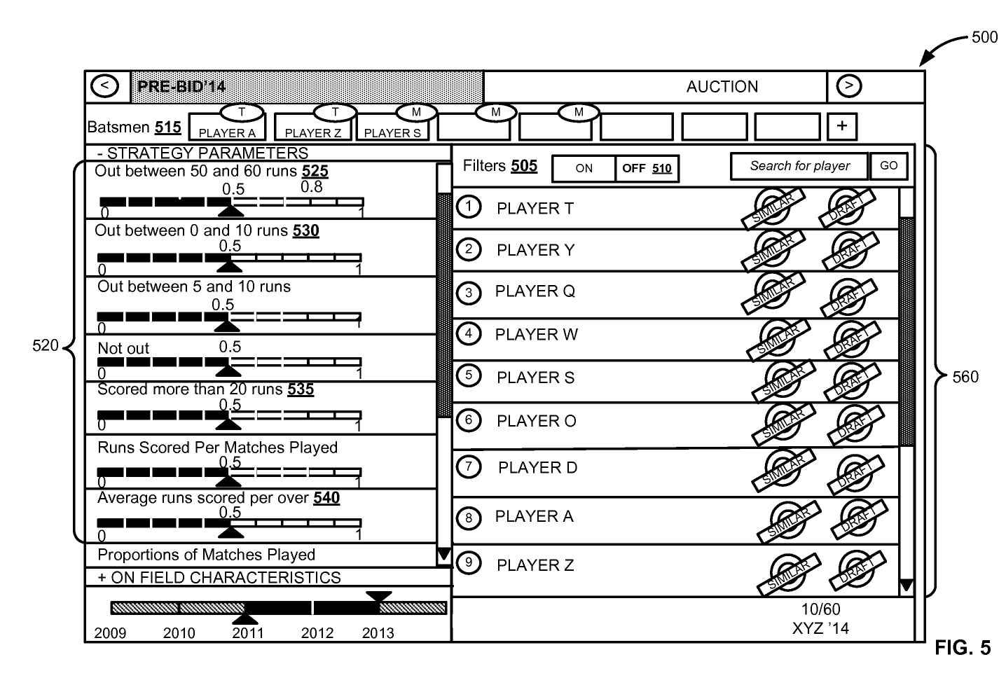

FIG. 5 illustrates user interface 500 to facilitate switching off filter parameters in dynamically ranking players, according to one embodiment. Consider a pre-bid example scenario, where the filters option 505 is set to ‘off’ 510. When the filters option is set to ‘off’ 510, strategy parameters are reset to a default uniform weight for selection of players in batsmen category 515. Various strategy parameters defined by the franchisee are shown in window 520. The various strategy parameters are ‘out between 50 and 60 runs’ 525, ‘out between 0 and 10 runs’ 530, ‘scored more than 20 runs’ 535, etc., as shown in window 520. When the filters option 505 is set to ‘off’ 510, these individual strategy parameters are associated with a default uniform weight which indicates that equal importance is associated with the strategy parameters. Default uniform weight may be any user-defined value such as 0.5, 1, 2, etc., specified by a user. For the strategy parameter ‘out between 50 and 60 runs’ 525 a default user-defined weight of 0.5 is associated, for the strategy parameter ‘out between 0 and 10 runs’ 530 the default user-defined weight of 0.5 is associated, for the strategy parameter ‘average runs scored per over’ 540 the default user-defined weight of 0.5 is associated, etc. Based on these weights, dynamic ranking of players is performed, e.g., according to steps 305 to 355 as explained in reference to flow diagram FIG. 3. The players are dynamically ranked in descending order of computed score and displayed as shown in window 560, such as ‘Player T’ in first rank, ‘Player Y’ in second rank, ‘Player Q’ in third rank, etc.

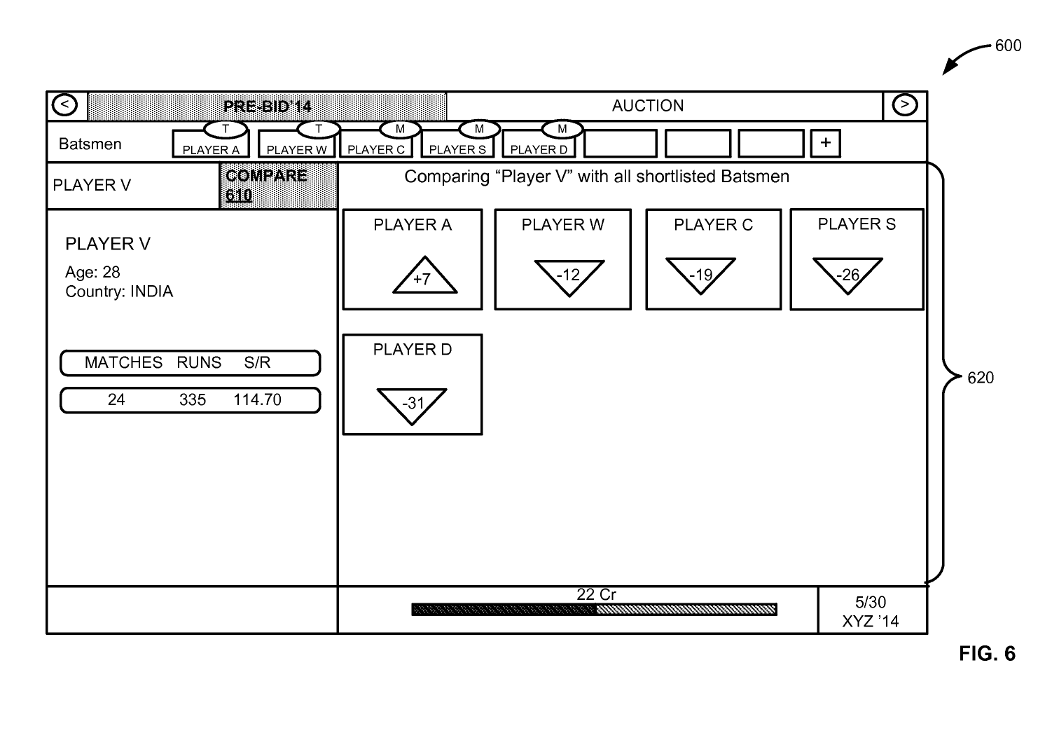

FIG. 6 illustrates user interface 600 to facilitate comparing players in predictive analytics application, according to one embodiment. Consider a pre-bid scenario with three shortlisted players ‘Player A’, ‘player W’ and ‘player C’. ‘Player A’ is dynamically ranked and shortlisted using a first set of strategy parameters, weights associated with the strategy parameters and filter parameters. ‘Player W’ is dynamically ranked and shortlisted using a second set of strategy parameters, weights associated with the strategy parameters and filter parameters. ‘Player C’ is dynamically ranked and shortlisted using a third set of strategy parameters, weights associated with the strategy parameters and filter parameters. If a new player ‘player V’ not considered or missed while shortlisting in the pre-bid scenario is identified, this new player ‘player V’ can be compared, e.g., using option ‘compare’ 610, and relatively ranked with reference to the players in a data pool. The individual players in the data pool were ranked based on different strategy parameters, weights associated with the strategy parameters and filter parameters. These players can be relatively dynamically ranked based on a single set of parameters for comparison on a common scale.

By way of example, one of the players, say ‘player A’, is selected, and the first set of strategy parameters, weights associated with the strategy parameters and filter parameters specified while dynamically ranking ‘Player A, is applied to ‘player V’ and all the players in the data pool including ‘Player A’. The players in the data pool including ‘player A’ may be dynamically ranked (steps 305 to 355 in FIG. 3) based on the same first set of strategy parameters, associated weights and filter parameters. As a result, ‘player A’ is ranked ‘1’ and ‘player V’ is ranked ‘8’. The difference between the ranks of ‘player V’ ‘8’ and ‘Player A’ ‘1’ is determined as +7. This rank +7 is displayed against ‘player A’ within a triangle pointing upwards indicating that ‘player A’ is 7 positions ahead of ‘player V’ Similarly, ‘player W’ is selected, and the second set of strategy parameters, weights associated with the strategy parameters and filter parameters specified while dynamically ranking ‘Player W’ is applied to rank ‘player V’ and the players in the data pool including ‘player A’. ‘Player W’ may be ranked ‘20’ and ‘player V’ may be ranked ‘9’. The difference between rank of ‘player V’ ‘9’ and rank of ‘Player W’ ‘20’ is determined as −11. This rank -11 is displayed against ‘player W’ within a triangle pointing downwards indicating that ‘player W’ is 11 positions behind ‘player V’ as shown in window 620.

FIG. 7 illustrates clustering 700 to identify similar players in predictive analytics application, according to one embodiment. Consider, for example, a data pool of two hundred players, and consider ‘Player A’ dynamically ranked and shortlisted using a first set of strategy parameters, weights associated with the strategy parameters and filter parameters. To find all players similar to ‘player A’, the first set of strategy parameters, weights associated with the strategy parameters and filter parameters is applied to the rest of the players, and individual scores of strategy parameters are computed, e.g., iteratively executing steps 305 to 355 of FIG. 3 per player. By way of example, the individual players of the two hundred players with individual scores of strategy parameters can be alphabetically ordered.

In one embodiment, K-means clustering algorithm is applied on these individual scores of strategy parameters to find ‘K’ clusters (segments) in the data. For example consider a cluster size of ‘3’ for applying the K-means clustering algorithm. Since the cluster size is ‘3’, the complete list of two hundred players is split into ‘3’ equal parts and the first player in every part is considered as initial centroid. Let the first player in first part be player ‘P1’, first player in second part be player ‘P5’, first player in third part be player ‘P10’, etc. Let individual scores of strategy parameters be S1^{P1} to S10^{P1} for player ‘P1’, individual scores of strategy parameters be S1^{P5} to S10^{P5} for player ‘P5’, etc. ‘K’ initial centroids are chosen, where ‘K’ represents the number of clusters to be found, and cluster 1 (C1) is represented by centroid K1, cluster 2 (C2) is represented by centroid K2, cluster 3 (C3) is represented by centroid K3. These initial centroids K1, K2 and K3 are indicated with ‘+’ sign.

The distance of each player from the centroid is computed and a player is assigned to a cluster that has minimum distance between the centroid and the player. Each of the individual scores of strategy parameters of the players are considered to compute Euclidean distance to assign the players to the corresponding cluster. Euclidean distance is computed between player ‘P1’ and centroid ‘K1’, player ‘P1’ and centroid ‘K2’, player ‘P1’ and centroid ‘K3’, etc. The shortest Euclidean distance of player ‘P1’ from among the three centroids K1, K2 and K3 is determined. The distance between player ‘P1’ and ‘K3’ is determined as the shortest distance, and accordingly player ‘P1’ is assigned to centroid ‘K3’. Similarly, based on the individual scores of strategy parameters, the players are assigned to one of the three centroids K1, K2 and K3 based on the shortest Euclidean distance. The players ‘P2’, ‘P13’, ‘P7’ and ‘P15’ are assigned to centroids K1 and this referred to as cluster C1, players ‘P5’, ‘P9’, ‘P3’, ‘P24’, ‘P33’, ‘P67’ and ‘P188’ are assigned to centroids K2 and this referred to as cluster C2, and players ‘P1’, ‘P4’, ‘P27’, ‘P38’, ‘P44’ and ‘P69’ are assigned to centroids K3 and this referred to as cluster C3 as shown in first iteration in 700.

Consider players ‘P2’, ‘P13’, ‘P7’ and ‘P15’ assigned to centroids K1 in a first iteration, based on the individual scores of strategy parameters of the players in the cluster the centroid value is recomputed to update the cluster centroid. For example, K11 is the recomputed centroid of cluster C1 in ‘n^{th}’ iteration. Similarly, other updated centroid values are recomputed as K12 and K13 in ‘n^{th}’ iteration. Each of the players from among the two hundred players are assigned to one of the closest centroids K11, K12 and K13 by computing Euclidean distance as described above. In ‘n^{th}’ iteration, players ‘P2’, ‘P4’, ‘P5’, ‘P7’ and ‘P24’ are assigned to recomputed centroid K11 and this is referred to as new cluster centroid for cluster C1, players ‘P9’, ‘P15’, ‘P69’, ‘P33’, ‘P67’ and ‘P44’ are assigned to recomputed centroid K12 and this is referred to as new cluster centroid for cluster C2, and players ‘P1’, ‘P27’, ‘P38’, ‘P3’, ‘P13’ and ‘P188’ are assigned to recomputed centroid K13 and this is referred to as new cluster centroid for cluster C3. This process is repeated iteratively until the players do not switch clusters or a pre-defined number of iterations are reached. Similar entities or players are identified based on the position in cluster and displayed in a user interface 800 of FIG. 8 as explained below.

FIG. 8 illustrates user interface 800 to displaying similar players in predictive analytics application, according to one embodiment. To find all players similar to player ‘P15’, the cluster where player ‘P15’ is positioned or the cluster to which player ‘P15’ belongs is identified in FIG. 7. Player ‘P15’ belongs to or is positioned in cluster C2, and the players in cluster C2 are identified as players similar to player ‘P15’. Therefore, player ‘P9’, player ‘P33’, player ‘P44’, player ‘P67’ and player ‘P69’ in cluster C2 are displayed as players similar to player ‘P15’. Player ‘P9’ is displayed with rank indicated as ‘7’ along with details corresponding to player ‘P9’ as shown in row 810. Player ‘P33’ is displayed with rank indicated as ‘10’ along with details corresponding to player ‘P33’ as shown in row 820. Other similar players ‘P44’, player ‘P67’ and player ‘P69’ are displayed in the user interface 800.

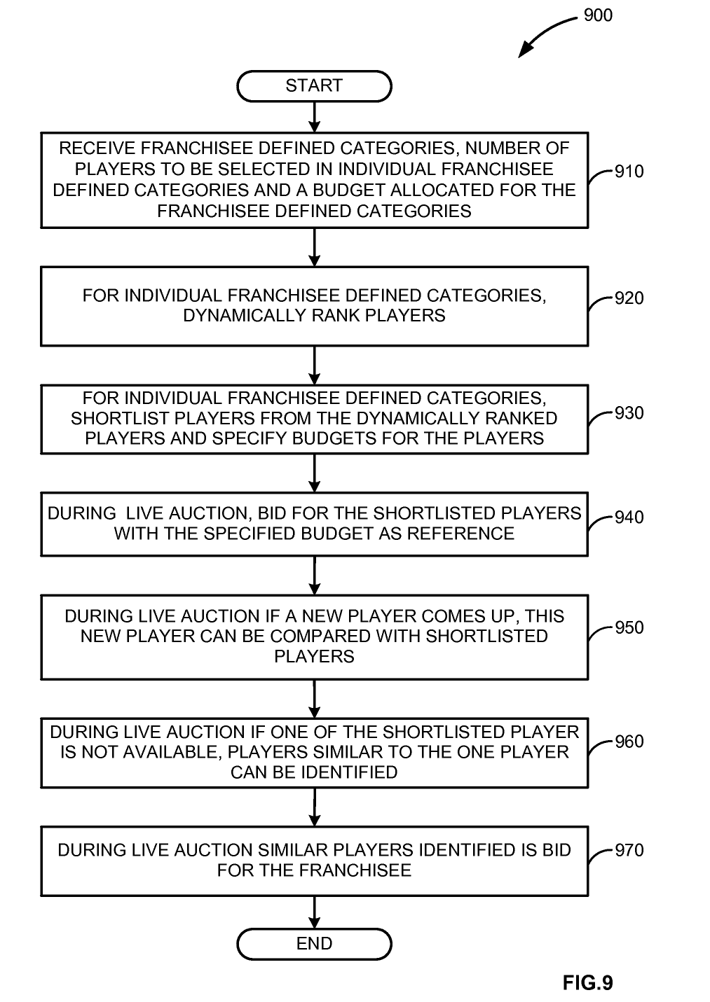

FIG. 9 is a flow diagram illustrating process 900 of live auction using pre-bid players, according to one embodiment. At 910, in the user interface of predictive analysis application, franchisee can define categories or buckets referred to as ‘franchisee defined categories’ are received. These ‘franchisee defined categories’ indicate the strategy to be adopted by the franchisee in choosing players during the auction. In individual franchisee defined categories, number of players to be selected and a budget allocated for that franchisee defined category are specified. At 920, for individual franchisee defined categories, players are dynamically ranked, e.g., as described in reference to steps 305 to 355 of FIG. 3. At 930, for individual franchisee defined categories, players are shortlisted from the dynamically ranked players. Budgets are specified for the shortlisted players. During live auction, at 940, shortlisted players are bid with the budgets specified as reference. During live auction, at 950, if a new player not available in the shortlisted list comes up, this new player can be compared with the shortlisted players, e.g., as explained in reference to FIG. 6. During live auction, at 960, if one of the shortlisted players is not available during auction, players similar to that one shortlisted player are identified, e.g., as explained in reference to FIG. 7 and FIG. 8. At 970, the identified similar players are displayed for bidding by the franchisee during the auction. During auction a dashboard of live feed is provided to the franchisee which provides a snapshot of its own team. Amount spent on players and a balance amount available is compared and provided on a real-time basis. In addition the franchisee can also see a similar dashboard of other competing franchisees and perform strategic decisions in real-time.

The various embodiments described above have a number of advantages. Quantitative facts analyzed for players are used in dynamically predicting and generating insights on entities during pre-bid. Using the predictive analytics application, individual franchisee can have their own strategy in bidding entities such as players. During live auction, comparison features is efficient in providing comparison among the selected players. During auction, players come up in random order for auction. “The similar player feature” is efficient in identifying players similar to a player bought by a different franchisee. The features in predictive analytics application enables a franchisee to bid entities in real-time based on the insight generated during pre-bid and live auction.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

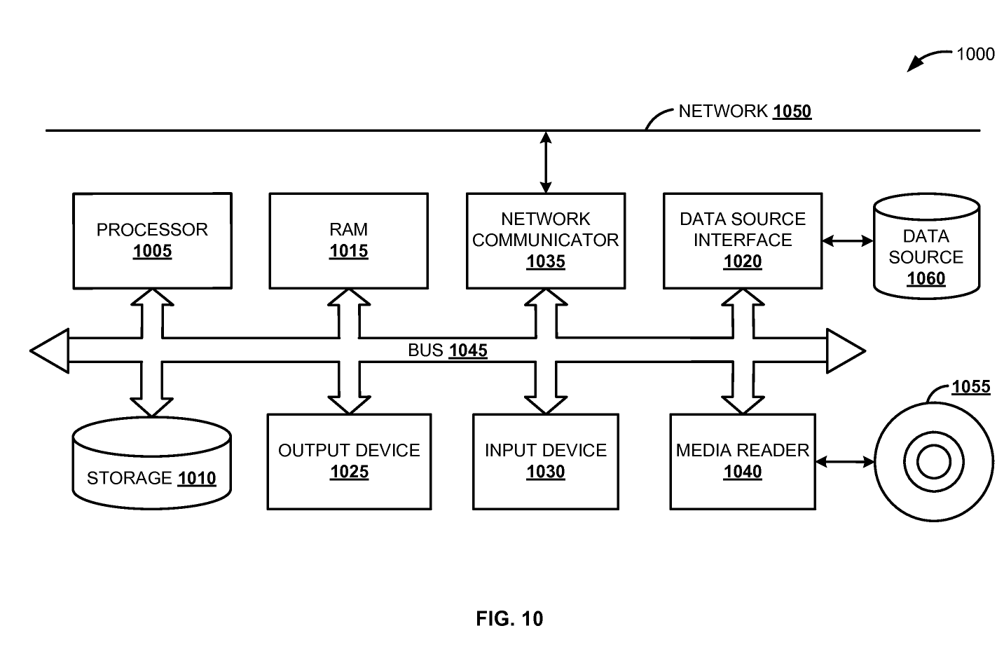

FIG. 10 is a block diagram of an exemplary computer system 1000. The computer system 1000 includes a processor 1005 that executes software instructions or code stored on a computer readable storage medium 1055 to perform the above-illustrated methods. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
receive strategy parameters and weights associated with the strategy parameters to dynamically rank entities;
normalize raw values associated with the strategy parameters by applying transformation functions;
compute weighted normalized values based on the normalized raw values and the weights associated with the strategy parameters;
compute aggregate scores based on the weighted normalized values;
dynamically rank the entities based on the computed aggregate scores; and
display the dynamically ranked entities on a user interface of a predictive analytics application.

2. The computer-readable medium of claim 1, wherein the entities are filtered based on specified filter parameters.

3. The computer-readable medium of claim 2, further comprising instructions which when executed by the computer further causes the computer to:
reset the weights associated with the strategy parameters to default weights when the filtering based on the filter parameters is switched off.

4. The computer-readable medium of claim 1, further comprising instructions which when executed by the computer further causes the computer to:
determine a set of strategy parameters, weights associated with the set of strategy parameters and filter parameters associated with a first entity for comparison;
apply the determined set of strategy parameters, weights associated with the set of strategy parameters, and filter parameters to the entities, wherein the entities comprise an entity to be compared;
normalize raw values associated with the set of strategy parameters by applying transformation functions;
compute weighted normalized values for the set of strategy parameters based on the normalized raw values and the weights associated with the set of strategy parameters;
compute new aggregate scores based on the weighted normalized values for the set of strategy parameters;
dynamically rank the entities based on the computed new aggregate scores; and
display a relative difference in rank between the entities and the entity to be compared, and the first entity for comparison and the entity to be compared.

5. The computer-readable medium of claim 1, further comprising instructions which when executed by the computer further causes the computer to:
apply clustering algorithm on the computed aggregate scores to form clusters of aggregate scores, wherein the aggregate scores correspond to the entities;
receive an entity as input to identify entities similar to the received entity;
identify a cluster to which the received entity belongs; and
display the entities in the identified cluster as similar entities.

6. The computer-readable medium of claim 1, further comprising instructions which when executed by the computer further causes the computer to:
dynamically adjust the weights associated with the strategy parameters to re-rank dynamically ranked entities.

7. The computer-readable medium of claim 1, further comprising instructions which when executed by the computer further causes the computer to:
assign entity budgets to the dynamically ranked entities as a reference during auction.

8. A computer-implemented method for dynamic predictive analysis in pre-bid of entities, the method comprising:
receiving strategy parameters and weights associated with the strategy parameters to dynamically rank entities;
normalizing raw values associated with the strategy parameters by applying transformation functions; computing weighted normalized value based on the normalized raw values and the weights associated with the strategy parameters;
computing aggregate scores based on the weighted normalized values;
dynamically ranking the entities based on the computed aggregate scores; and
displaying the dynamically ranked entities on a user interface of a predictive analytics application.

9. The method of claim 8, wherein the entities are filtered based on specified filter parameters.

10. The method of claim 9, further comprising instructions which when executed by the computer further causes the computer to:
resetting the weights associated with the strategy parameters to default weights when the filter parameters are switched off.

11. The method of claim 8, further comprising instructions which when executed by the computer further causes the computer to:
determining a set of strategy parameters, weights associated with the set of strategy parameters and filter parameters associated with a first entity for comparison;
applying the determined set of strategy parameters, weights associated with the set of strategy parameters, and filter parameters to entities, wherein the entities comprise an entity to be compared;
normalizing raw values associated with the set of strategy parameters by applying transformation functions;
computing weighted normalized value for the set of strategy parameters based on the normalized values and the weights associated with the set of strategy parameters;
computing new aggregate scores based on the weighted normalized values for the set of strategy parameters;
dynamically ranking the entities based on the computed new aggregate score; and
display a relative difference in rank between the entities and the entity to be compared, and the first entity for comparison and the entity to be compared.

12. The method of claim 8, further comprising instructions which when executed by the computer further causes the computer to:
applying clustering algorithm on the computed aggregate scores to form clusters of aggregate scores, wherein the aggregate scores correspond to the entities;
receiving an entity as input to identify entities similar to the received entity;
identifying a cluster to which the received entity belongs; and
displaying the entities in the identified cluster as similar entities.

13. The method of claim 8, further comprising instructions which when executed by the computer further causes the computer to:
dynamically adjusting the weights associated with the strategy parameters to re-rank dynamically ranked entities.

14. The method of claim 8, further comprising instructions which when executed by the computer further causes the computer to:
assigning entity budgets to the dynamically ranked entities as a reference during auction.

15. A computer system for dynamic predictive analysis in pre-bid of entities, comprising:
a computer memory to store program code; and
a processor to execute the program code to:
receive strategy parameters and weights associated with the strategy parameters to dynamically rank entities;
normalize raw values associated with the strategy parameters by applying transformation functions;
compute weighted normalized value based on the normalized values and the weights associated with the strategy parameters;
compute aggregate scores based on the weighted normalized values;
dynamically rank the entities based on the computed aggregate score; and
display the dynamically ranked entities on a user interface of a predictive analytics application.

16. The system of claim 15, wherein the entities are filtered based on specified filter parameters.

17. The system of claim 16, further comprising instructions which when executed by the computer further causes the computer to:
reset the weights associated with the strategy parameters to default weight when the filtering based on the filter parameters are switched off.

18. The system of claim 15, further comprising instructions which when executed by the computer further causes the computer to:
determine a set of strategy parameters, weights associated with the set of strategy parameters and filter parameters associated with a first entity for comparison;
apply the determined set of strategy parameters, weights associated with the set of strategy parameters, and filter parameters to entities, wherein the entities comprise an entity to be compared;
normalize raw values associated with the set of strategy parameters by applying transformation functions;
compute weighted normalized values for the set of strategy parameters based on the normalized raw values and the weights associated with the set of strategy parameters;
compute new aggregate scores based on the weighted normalized values for the set of strategy parameters;
dynamically rank the entities based on the computed new aggregate score; and
displaying a relative difference in rank between the entities and the entity to be compared, and the first entity for comparison and the entity to be compared.

19. The system of claim 15, further comprising instructions which when executed by the computer further causes the computer to:
apply clustering algorithm on the computed aggregate scores to form clusters of aggregate scores, wherein the aggregate scores correspond to the entities;
receive an entity as input to identify entities similar to the received entity;
identify a cluster to which the received entity belongs; and
display the entities in the identified cluster as similar entities.

20. The system of claim 15, further comprising instructions which when executed by the computer further causes the computer to:
dynamically adjust the weights associated with the strategy parameters to re-rank dynamically ranked entities.
